(19) United States
(12) Patent Application Publication
(10) Pub. No.: US 2005/0044367 A1
(43) Pub. Date: Feb. 24, 2005

(54) Enabling and disabling software features

(76) Inventors: Stephane Christian Gasparini, Tournefeuille (FR); Yan Nicolas Bertrand, Toulouse (FR); Pascal Khair, Toulouse (FR)

Correspondence Address: MOTOROLA INC, 600 NORTH US HIGHWAY 45, ROOM AS437, LIBERTYVILLE, IL, 60048-5343, US

(21) Appl. No.: 10/677,775

(22) Filed: Oct. 2, 2003

(30) Foreign Application Priority Data
Mar. 25, 2002 (WO) PCT/EP02/03417
Apr. 2, 2001 (EP) 01400835.3

(51) Int. Cl. H04L 9/00

(52) U.S. Cl. 713/172

(57) ABSTRACT

This application relates to a method of enabling and disabling software features in a software-implemented feature set, to the software itself and to a device with the software thereon. In accordance with the method of the invention, a token formed from identification and feature related information is sent to an authorization device. The authorization device creates a key from this information and sends the key and information on the authorized feature set back to the device. The device generates its own version of the key and compares its version with the received version. If the two keys match, the authorized feature set is implemented.

### FIELD OF THE INVENTION

The present invention relates to enabling and disabling software features and in particular to changing the available features in a software-implemented feature set.

### BACKGROUND

It is known for suppliers of software or devices incorporating software to supply different versions of the same product having different feature sets. However, increasingly software which implements or provides features or functions is being developed containing software blocks corresponding to all potentially available features. The different software blocks are then enabled and disabled as appropriate to produce different versions of the software or families of devices having different features. The term “fully featured software” is sometimes used for such software.

As an example, it is noted that increasingly fully featured software is being used in devices such as, but not limited to, mobile radio-telephones, mobile radios, personal digital assistants and computers, and different models or families of products with different features are created by selective enablement of the corresponding software blocks.

Consumers may wish to temporarily or permanently alter the set of enabled features provided by the software from the feature set initially available and so it is desirable to provide a simple mechanism by which an enabled feature set in fully featured software can be altered.

It is known for demonstration versions of software to be made available to the public. It is sometimes possible to unlock the demonstration software on payment of a fee to obtain full use of the software. One known method for unlocking software requires the user to supply an authorizing agent, such as the software supplier, with the user's name. The authorizing agent uses a secret algorithm or secret code to generate an unlock code using the user's name and provides the unlock code to the user. The user enters the unlock code and the user name and the software uses the same secret algorithm or secret code to generate a confirmation unlock code. If the confirmation unlock code matches the unlock code entered by the user, the software is unlocked.

However, once the software has been unlocked there is no protection against further copying of the unlocked software onto other machines. This is clearly undesirable to the software provider. In addition, there is no mechanism provided to allow enabling or disabling of software on a feature by feature basis.

### BRIEF DESCRIPTION OF THE DRAWINGS

For a better understanding of the present invention, and to show how it may be brought into effect, reference will now be made, by way of example, to the accompanying drawings, in which:

FIG. 1 shows a communication device;

FIG. 2 shows an exemplary illustration of a tree of messages that might be displayed on the display of a communication device;

FIG. 3 shows a method of enabling a portion of software in order to make a corresponding feature available;

FIG. 4 shows an exemplary illustration of a tree of messages with a displayed token;

FIG. 5 shows an exemplary illustration of a tree of messages with an enabled feature; and

FIG. 6 illustrates in more detail the unlocking procedure.

### DETAILED DESCTRIPTION

In accordance with the described embodiment of the invention, a feature change procedure is provided to change the availability to the user of one or more features in a software-implemented feature set containing a plurality of features.

This is achieved using a feature change key which authorizes the locking or unlocking, as appropriate, of different features in the feature set. The feature change key is derived from a token generated by the software or the device containing the software. As a result, the feature change key is specific to the particular software or device in which the software is loaded and cannot be used to alter the availability of features on any other software or device. Moreover, the feature change key is specific to the authorized feature set and thus enables alteration of the feature set on a feature-by-feature basis.

The feature change procedure can be carried out by the software or device user, by an after-sales representative, or at the point of sale, for example. Moreover, the exchange of information described can be achieved in a variety of ways, for example by means of the user interface of the device, or by way of any communication protocol between the device and a network server or other authorization device.

The following description of an exemplary embodiment relates to the use of an unlock key to unlock a desired feature by the end user of a communication device by means of a user interface. However, it will be understood by a skilled person that other arrangements and embodiments of the invention are possible and the present invention is not limited to the described arrangements. Moreover, it will be clear that the invention is applicable to devices other than communication devices and to both a device loaded with the software and to the software itself. Most preferably, the invention can be used in devices with embedded fully featured software, such as mobile or portable communications devices or personal digital assistants.

In addition, it will be clear to a skilled person that the invention is not limited to unlocking of features, but is also applicable to any alteration in the feature set, such as the locking of features, or the simultaneous locking and unlocking of different features within the feature set using the same feature change key.

In accordance with the described embodiment, the exemplary communication device is provided with fully featured software, which implements a plurality of features. Of these features, only a subset is enabled in the exemplary communication device.

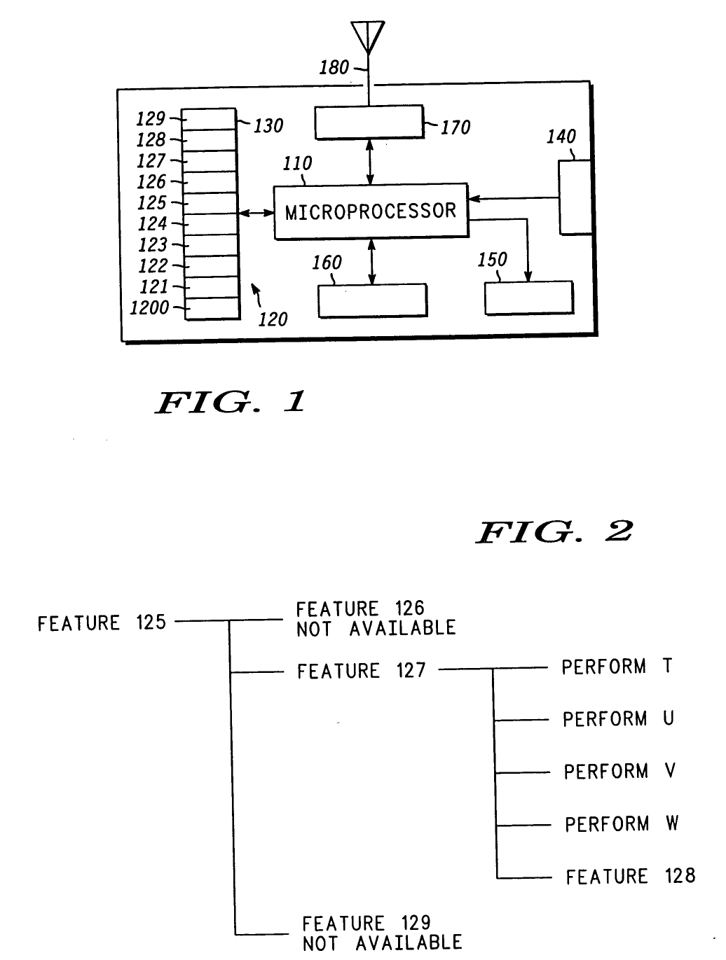

The communication device 100 is shown in FIG. 1. The exemplary communication device 100 has a microprocessor 110 which controls the operation of the communication device under the control of software 120 stored in the program memory 130. The communication device 100 has input and output devices, such as a keyboard 140 and a display 150 for enabling interaction with the user of the communication device 100. The communication device 100 also has a memory 160 for storing data used during operation of the communication device. The program memory and the data memory are shown as separate memories. However, they may also be implemented as different logical parts of the same memory. At least part of the memory 160 is non-volatile. The exemplary communication device also has a communications section 170 connected to an antenna 180. Clearly the communications section 170 and antenna 180 could be omitted in other devices which do not require communications capability.

The software 120 stored in the program memory 130 controls the operation of the communication device, and is arranged into software elements or blocks. Software elements 121, 122 etc. each control a particular function or feature.

In the exemplary embodiment shown, software elements 125-129 relate to optional features of which software elements 125, 127 and 128 are enabled, such that those features are available to the user of the communication device. In contrast, elements 126 and 129 are not enabled, and the corresponding features are not available to the user of the communication device. Software element 1200 implements the feature change to alter the enablement of the software elements 125-129, and hence the availability of the corresponding features to the user.

The user interacts with the communication device by means of the user interface provided by the software and the keyboard 140 and the display 150. An exemplary illustration of a tree of messages that might be displayed on the display is shown in FIG. 2. Although the exemplary illustration shows a hierarchy of features, it will be clear to a skilled person that such a hierarchical arrangement of features is not necessary to the invention.

FIG. 2 shows that feature 125 has three sub-features 126, 127 and 129. In turn feature 127 has four available actions, action T, action U, action V and action W, together with a further sub-feature 128. Currently features 125, 127 and 128 are available, or unlocked, and features 126 and 129 are locked, or unavailable.

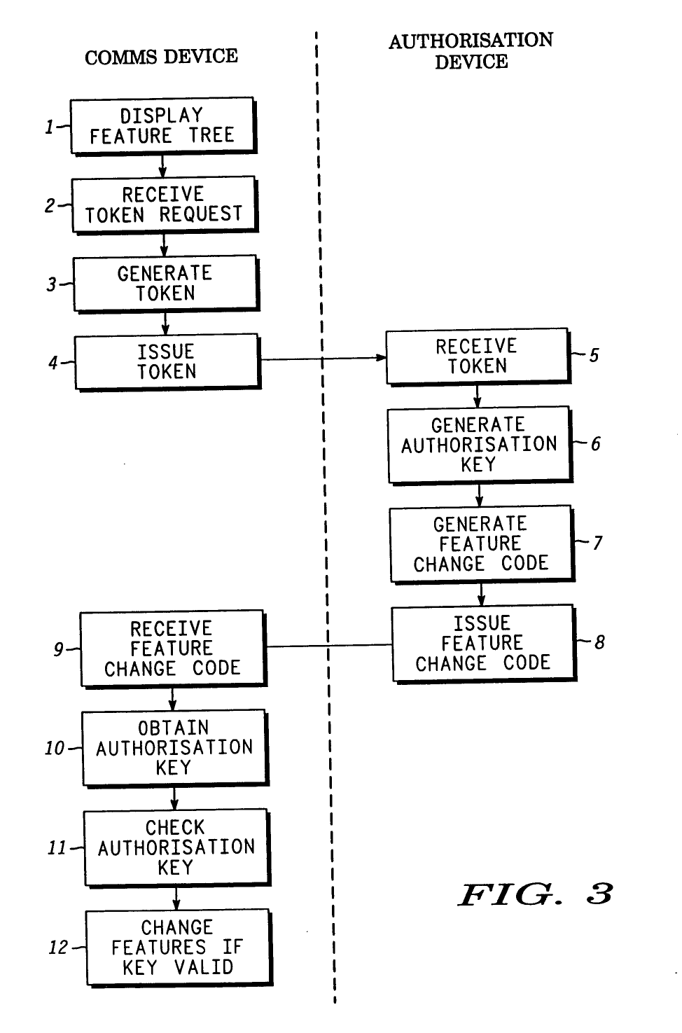

If the user wishes to use feature 126, this feature must be unlocked by enabling the corresponding software block 126. The method of enabling a portion of software in order to make a corresponding feature available will now be described with reference to FIG. 3.

When the communication device displays the feature tree (step 1), such as the feature tree shown in FIG. 2, the user can select the feature it is desired to unlock. The unlocking procedure is initiated with a token generation request received by the communication device 100 (step 2). The user can request a token by pressing a dedicated key or by selecting a menu item in the user interface, for example.

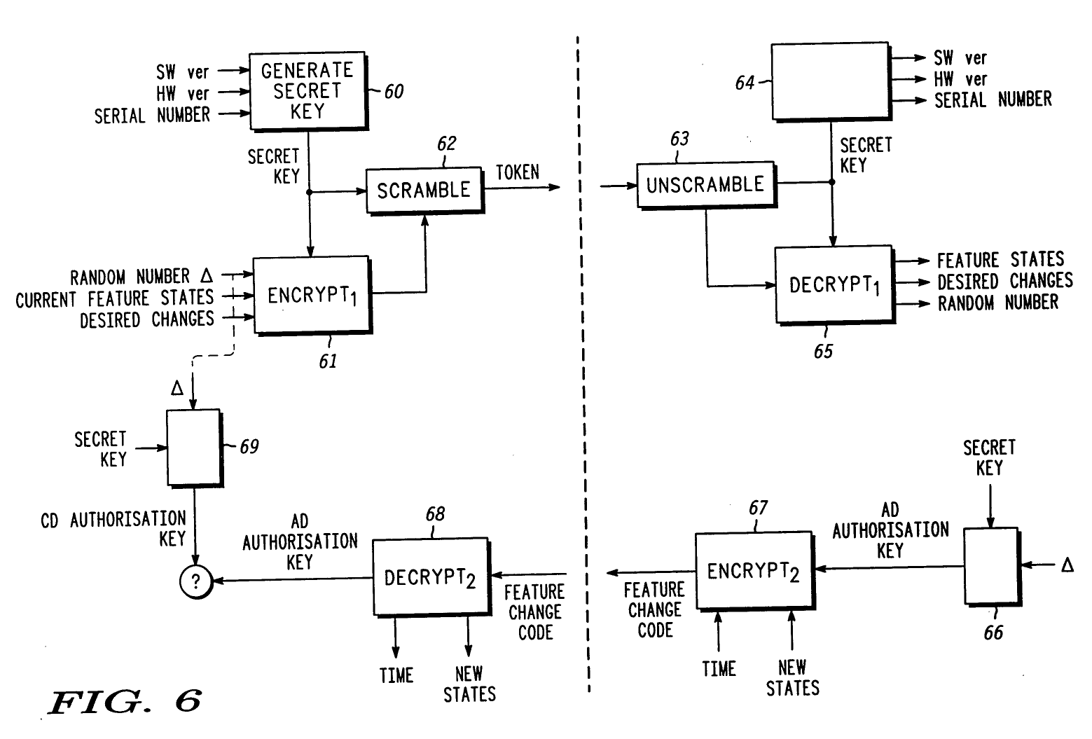

In response to the request from the user for a token, the communication device generates a token (step 3). The generation of the token will be described in more detail with reference to FIG. 6.

The generated token is then issued by the communication device and subsequently received by the authorization device (steps 4 and 5). The secure authorization device may be a secure website, for example.

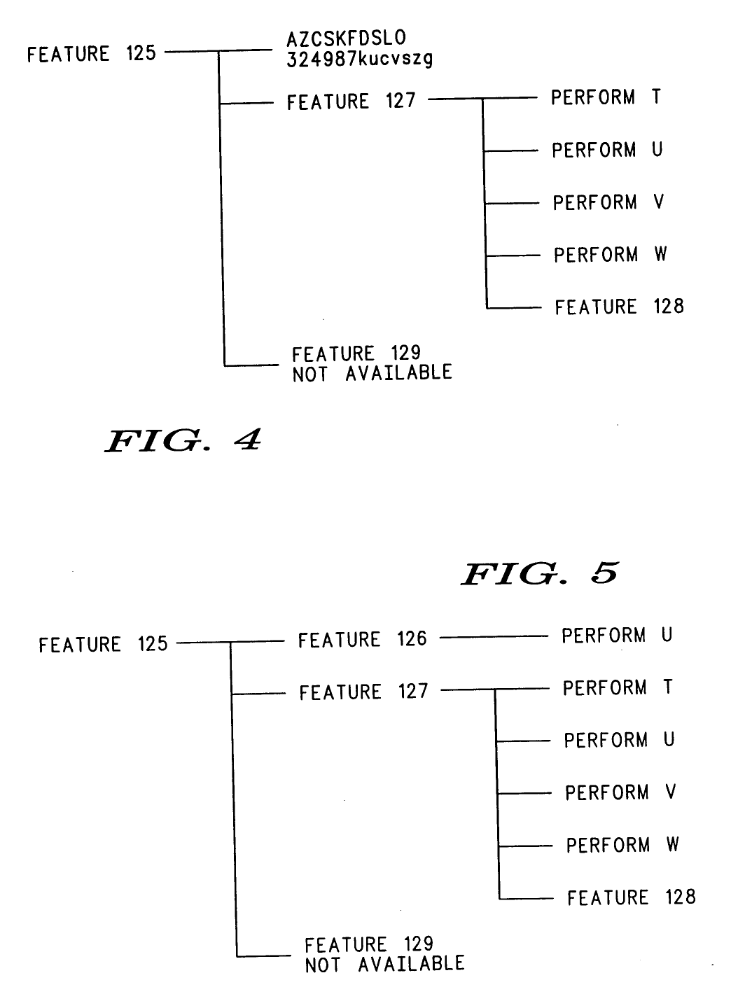

One way of achieving this is for the generated token to be displayed on the display 150 of the communication device 100 (step 4). An exemplary illustration of such a displayed token is shown in FIG. 4.

The user can read the token from the display and submit it to the secure authorization device. However, clearly this transfer can be achieved in a number of different ways as will be apparent to a skilled person.

The authorization device receives the token (step 5) and uses information derived from the token to generate an authorization key (step 6) which is, in turn, used to generate a feature change code (step 7) which is issued by the authorization device (step 8) and subsequently received by the communication device (100).

The user can input the feature change code from the authorization device into the communication device 100 (step 9). The communication device 100 obtains an authorization key from the feature change code (step 10). The communication device 100 checks the authorization key to confirm authorization for feature release (step 11) and if the unlock key is valid, the software 126 is enabled and access is granted to feature 126 (step 12). Preferably, the user interface is then updated to reflect the addition of the feature 126 to the feature set available on the communication device, as illustrated, for example in FIG. 5.

Although the embodiment has been described in steps 4 and 5 and steps 7 and 8 as using the user interface, these steps could be provided automatically via any interface between the communication device and the authorization device. In particular, the token and the feature change code may be transferred between the communication device and the authorization device by conventional mail, email, internet, wireless internet, Bluetooth™, voice or any suitable communication protocol. In particular, this interface may be provided by means of secure wireless access using the communication section 170 and the antenna 180 via a cellular wireless communication or wireless Local Area Network (LAN) to a secure server acting as the authorization device.

The formation of the token and the feature change code will now be described in more detail with reference to FIG. 6.

In response to the receipt of a token request, the communication device generates a token using identification information and feature related information. Advantageously a random number is also used in the generation of the token. The use of the random number provides additional security and protection against unauthorized decryption.

Identification information may be software related information, for example a software identification number, which uniquely identifies the software, and/or device related data, and/or subscriber identification information. Device related data may be, for example, the Device Identification Number (DIN), which is a unique serial number of a communication device, or other device identification information. Subscriber identification information, for example as recorded in a SIM (Subscriber Identity Module) card, can also be used.

In addition, information such as the hardware version and/or the software version of the communication device can advantageously be used. A higher lever of security may be provided with the use of such additional information because an attempt to lock or unlock a feature which is not provided by or supported by the communication device can be avoided. In the exemplary embodiment shown in FIG. 6, the DIN, software and hardware versions are all used as identification information in the token generation procedure.

The feature related information may be information relating to the current feature states and desired feature states. However, information relating to the alteration in features availability may be provided in another way, for example, the feature related information may relate only to the required change in feature availability. Preferably, the feature states are represented by the state of respective bits corresponding to features in the feature set, where a “1” indicates that the corresponding feature is enabled and a “0” indicated that the corresponding feature is not enabled.

Preferably, the feature-related information and the random number, if used, should be stored in non-volatile memory.

In order to generate a token from this identification information and feature related information, firstly, a secret key is generated from the identification information in a secret key generation step 60. The algorithm used for secret key generation can be any suitable algorithm known by a skilled person.

The secret key is used to encrypt feature related information in an encrypting step 61. In the illustrated example, the feature related information is information relating to the features availability alteration being requested, for example relating to the current feature states and desired feature states.

In the exemplary embodiment, a random number delta is also used in the encrypting step 61 to improve security.

In an advantageous embodiment (not shown) it can be seen that payment information can be included in the token, for example payment information is also encrypted using the secret key in encryption step 61.

The encrypted information is then scrambled with the secret code in a scrambling step 62 to form the token which is transmitted to the authorization device. The scrambling prevents the transmission in clear of the secret key, adding to the security of the system. As indicated earlier, the transmission may be achieved in a variety of ways.

In the authorization device, the received token is unscrambled in an unscrambling step 63 to obtain the secret key and the encrypted information. The DIN, software and hardware version information can be obtained from the unscrambled secret key in step 64, which performs a reverse operation to that performed in the secret key generation step 60.

The secret key can then be used in step 65 to decrypt the feature related information and the random number delta, if used.

Thus the authorization device has all necessary information relating to the identity of the software or of the device and the desired feature state. Preferably, the authorization device maintains or has access to records relating to the hardware/software version number features and checks the suitability of the requested feature alteration. The authorization device also handles any payment required for the feature alteration, such as a fee for feature unlocking or a refund for feature locking. As indicated previously, in an advantageous embodiment the payment information is also included in the token.

Once the change in the available feature state is authorized, in order to confirm authorization of the requested feature alteration an Authorization Device (AD) authorization key is generated by the authorization device using a non-reversible operation.

In the described exemplary embodiment, a non-reversible operation is performed in step 66 on the random number delta and the secret key to obtain the AD authorization key. However, as indicated above, the use of a random number is not essential to the invention, and the AD authorization key can be generated by a non-reversible operation on any information related to the software or to the device known by the authorization device and by the communication device. Preferably, this information is information that has been sent from the communication device to the authorization device. In particular, the AD authorization key may be formed using the DIN instead of a random number. Use of the random number is preferable since this ensures that the AD authorization key is different for successive feature alteration requests, and so provides enhanced security.

The AD authorization key and the information relating to the authorized feature set are encrypted in step 67 to generate the feature change code. The authorized feature set information may be feature state information for all states or information relating specifically to the feature state or states being altered, for example. In the illustrated embodiment, the authorized feature set information is new state information.

The encryption algorithm used in step 67 may be the same as that used in step 61 or may be a different encryption algorithm. In the exemplary embodiment shown in FIG. 6, information relating to time is also input to the encryption step 67 to obtain the feature change code to provide additional security.

As indicated earlier, the feature change code issued by the authorization device may be provided to the communication device in a variety of ways. On receipt of the feature change code, the communication device 100 decrypts information relating to the authorized feature set and the AD authorization key in step 68. Step 68 performs a reverse operation to the operation performed in step 67.

In addition, the communication device also generates its own Communication Device (CD) authorization key in step 69 using the same information and non-reversible operation used by the authorization device in step 66. In the described exemplary embodiment, the random number and the secret key are used to generate the CD authorization key.

Finally, the CD authorization key calculated by the communication device is compared with the AD authorization key decrypted from the received unlock code. If the AD authorization key matches the CD authorization key, the relevant feature availability change specified in the authorized feature set information can be implemented by the device, in this case the feature can be unlocked. If the AD authorization key does not match the CD authorization key, the unlock code is rejected by the communication device, and no feature availability change is made by the communication device.

The failure in feature availability change may be notified to the user or to the authorization device. To improve security, the communication device may be locked after a number of failed attempts.

Although the embodiment has been described above as relating to a single device and a remote authorization device, the invention can be implemented in other ways. For example, the invention may be implemented in a network in which feature change requests from a number of users are sent through a single server of the network, which gathers token requests and then transfers the feature change code back to the connected users. In this way the implementation of the described method on the “device” side may be distributed throughout a network. Equally, although described above as an authorization device, the implementation of the described method on the “authorization” side may be distributed throughout a network. The present invention is intended to cover all such modifications.

Thus, secure alteration of feature availability in fully featured software is described.

1. A method of changing the available features in a software-implemented feature set containing a plurality of features, comprising the steps:
forming a token from identification information and feature related information and issuing the token;
receiving the token and obtaining identification information and desired feature related information from the token;
in response to a determination to authorize change in the feature set, the further steps:
using the identification information to generate an authorization key;
forming a feature change code from the authorization key and information related to an authorized feature set and issuing the feature change code; and
receiving the feature change code and obtaining the authorization key and information related to the authorized feature set from the feature change code;
generating a local authorization key using the identification information;
comparing the received authorization key with the local authorization key; and
implementing the authorized feature set if the received authorization key and the local authorization key match.

2. A method of changing the available features in a software-implemented feature set containing a plurality of features, comprising the steps:
forming a token from identification information and feature related information and issuing the token;
receiving a feature change code and obtaining an authorization key and information related to an authorized feature set from the feature change code;
generating a local authorization key using the identification information;
comparing the received authorization key with the local authorization key; and
implementing the authorized feature set if the received authorization key and the local authorization key match.

3. The method as claimed in claim 1, wherein a random number is also used in the step of forming the token.

4. The method as claimed in claim 1, wherein a random number is also used in the step of generating the local authorization key.

5. The method as claimed in claim 1, wherein the identification information comprises data relating to at least one of a software identification number; a Device Identification number; a Subscriber Identification Number.

6. The method as claimed in claim 5, wherein the identification information also comprises hardware version number data or software version number data.

7. The method as claimed in claim 1, where the step of forming a token comprises the step of forming a secret key from the identification data and using the secret key as an encryption key to encrypt the feature related information.

8. The method as claimed in claim 1, where the step of generating a local authorization key comprises the step of forming a secret key from the identification data.

9. The method as claimed in claim 1, where the step of generating a local authorization key uses a non-reversible operation.

10. The method as claimed in claim 1, where the token contains payment information in respect of the requested feature alteration.

11. Apparatus comprising:
means for forming a token from identification information and feature related information
means for issuing the token;
means for receiving a feature change code
means for obtaining an authorization key and information related to an authorized feature set from the feature change code;
means for generating a local authorization key using the identification information;
means for comparing the received authorization key with the local authorization key; and
means for implementing the authorized feature set if the received authorization key and the local authorization key match.

12. A method of authorizing change in the available features in a software-implemented feature set containing a plurality of features, comprising the steps:
receiving a token;
obtaining identification information and feature related information from the token;
in response to a determination to authorize change in the feature set, the further steps:
using the identification information to generate an authorization key;
forming a feature change code from the authorization key and information related to the authorized feature set; and
issuing the feature change code.

13. The method as claimed in claim 12, wherein a random number is also obtained from the received token.

14. The method as claimed in claim 13, wherein the random number is used in the step of generating the authorization key.

15. The method as claimed in claim 12, wherein the identification information comprises data relating to at least one of a software identification number; a Device Identification number; a Subscriber Identification Number.

16. The method as claimed in claim 12, wherein the identification information also comprises hardware version number data or software version number data.

17. The method as claimed in claim 12, where the step of obtaining information from the token comprises the step of deriving a secret key and encrypted data from the received token and using the secret key as a decryption key to decrypt the encrypted data to obtain feature related information.

18. The method as claimed in claim 12, where the step of generating an authorization key comprises the step of forming a secret key from the identification data.

19. The method as claimed in claim 12, where the step of generating a local authorization key uses a non-reversible operation.

20. The method as claimed in claim 12 where payment information in respect of the requested feature alteration is obtained from the token.

21. Apparatus for authorizing change in the available features in a software-implemented feature set containing a plurality of features, comprising:
means for obtaining identification information and feature related information from a token;
means for determining to authorize change in the feature set
means for generating an authorization key using the identification information;
means for forming a feature change code from the authorization key and information related to the authorized feature set; and
means for issuing the feature change code.
